(19) United States
(12) Patent Application Publication
(10) Pub. No.: US 2025/0386157 A1
(43) Pub. Date: Dec. 18, 2025

(54) SYSTEM AND METHOD FOR DETECTING AND CORRECTING AUDIBLE DISTORTION

(71) Applicant: Google LLC, Mountain View, CA (US)

(72) Inventors: Olen Rasp, Mountain View, CA (US); Pei Chen Chuang, Taipei (TW); Gabriel Slotnick, Mountain View, CA (US); Wei Liang Liu, Taoyuan (TW)

(73) Assignee: Google LLC, Mountain View, CA (US)

(21) Appl. No.: 18/876,091

(22) PCT Filed: Jun. 30, 2022
(86) PCT No.: PCT/US2022/035821

§ 371 Date: Dec. 17, 2024

(51) Int. Cl. H04R 29/00; H04R 3/00; H04R 3/04

(52) U.S. Cl. CPC H04R 29/003; H04R 3/002; H04R 3/04; H04R 2430/01; H04R 2499/11

(57) ABSTRACT

Features described herein generally relate to detecting and correcting audible distortion due to speaker port occlusion. Particularly, an audio signal is output, an impedance curve for the audio signal is calculated, a change in a resonance frequency for the speaker based on an impedance curve model for the speaker and the impedance curve for the speaker is detected, and a gain of the amplifier is set based on the detected change in the resonance frequency for the speaker.

### FIELD

The present disclosure generally relates to audible distortion. Particularly, the present disclosure relates to a system and method for detecting and correcting audible distortion due to speaker port occlusion.

### BACKGROUND

Some portable electronic devices have a speaker for outputting audio. Generally, a housing for those portable electronic devices includes a speaker port through which air is moved by the speaker diaphragm of the speaker. Users of those portable electronic devices tend to grip those devices with their hands in such a way that their hands and/or fingers may block the speaker port. When the speaker port is blocked with a user's hands and/or fingers, audible distortion may occur and/or a user may experience physical discomfort.

### SUMMARY

Embodiments described herein pertain to a system and method for detecting and correcting audible distortion due to speaker port occlusion.

According to some embodiments, a method for correcting audible distortion in a portable electronic device includes outputting, from an amplifier to a speaker, a first audio signal, the first audio signal having a plurality of first frequencies; calculating, by a processing system coupled to the amplifier, a first impedance curve for the speaker based on the first audio signal; detecting, by the processing system, a change in a resonance frequency for the speaker based on an impedance curve model for the speaker and the first impedance curve for the speaker; and setting, by the processing system, a gain of the amplifier based on the detected change in the resonance frequency for the speaker.

In some embodiments, the method further includes outputting, from the amplifier to the speaker, a first test audio signal having a frequency and second test audio signal having a plurality of test frequencies.

In some embodiments, the method further includes calculating, by the processing system, an impedance curve model for the speaker based on the first test audio signal and the second test signal.

In some embodiments, calculating the impedance curve model includes obtaining an operating temperature measurement for a driver of the speaker while the speaker is driven with the first test audio signal; and obtaining voltage and current measurements for the driver of the speaker while the speaker is driven with the second test audio signal.

In some embodiments, calculating the impedance curve model further includes calculating an impedance curve for the speaker based on the voltage and current measurements for the driver of the speaker; and adjusting the calculated impedance curve for the speaker based on a relative resistance determined based on a change in the operating temperature measurement for the driver of the speaker.

In some embodiments, the first audio signal is output, from the amplifier to the speaker, for a first period of time, and wherein adjusting the gain of the amplifier comprises adjusting an amplitude of the first audio signal for a period of time equal to or less than the first period of time.

In some embodiments, adjusting the gain of the amplifier comprises adjusting a gain for each frequency of the plurality of first frequencies or a subset of frequencies of the plurality of first frequencies.

In some embodiments, the change in the resonance frequency for the speaker corresponds to a change in a port velocity for a speaker port included in a housing of the portable electronic device, the speaker port being comprised of a plurality of openings in the housing, wherein the change in the port velocity is caused by an obstruction of at least one opening of the plurality of openings.

In some embodiments, the method further includes outputting a message, by the processing system, the message indicating that a speaker port for the speaker is blocked.

In some embodiments, the speaker port includes a plurality of openings in the housing, and the change in the resonance frequency for the speaker corresponds to a change in a port velocity for the port caused by an obstruction of the port.

Some embodiments of the present disclosure include a portable electronic device including a housing that includes a speaker port, an amplifier, one or more speakers, one or more processing systems coupled to the amplifier, and one or more computer-readable storage media containing instructions which, when executed on the one or more processing systems, cause the one or more processing systems to perform part or all of the one or more operations and/or the one or more methods disclosed herein. Some embodiments of the present disclosure also include one or more non-transitory computer-readable media storing computer-readable instructions that, when executed by one or more processing systems, cause the one or more processing systems to perform part or all of the one or more operations and/or the one or more methods disclosed herein.

### BRIEF DESCRIPTION OF THE DRAWINGS

FIG. 1 shows an embodiment of a system for detecting and correcting audible distortion according to some aspects of the present disclosure.

FIG. 2 shows an embodiment of a portable electronic device according to some aspects of the present disclosure.

FIG. 3 shows an embodiment of a resonance shift according to some aspects of the present disclosure.

FIG. 4 shows another embodiment of the portable electronic device according to some aspects of the present disclosure.

FIG. 5 shows a flowchart of an embodiment of a process for detecting and correcting audible distortion according to some aspects of the present disclosure.

FIG. 6 shows a flowchart of an embodiment of a process for generating an impedance curve model according to some aspects of the present disclosure.

FIG. 7 shows an exemplary embodiment of a portable electronic device according to some aspects of the present disclosure.

### DETAILED DESCRIPTION

Portable electronic devices typically include at least one speaker for outputting audio. This audio often corresponds to music, video, streaming content, and operational sounds of the devices incorporating the speaker and is output in a range of frequencies (e.g., 20 Hertz to 20,000 Hertz). The speakers incorporated in these devices are typically arranged in a particular location within a housing for these devices with each speaker having a speaker port that is incorporated in the housing. In some cases, these speaker ports are formed with a plurality of through holes in the housing. In other cases, the speaker ports are formed by a single opening in the housing. Such an opening can be covered by a mesh screen. When the speaker is driven, air is pushed from the speaker diaphragm through the speaker port. Users of portable electronic devices may hold and grip these devices with their hands in such a way that their hands and/or fingers block the speaker ports of those devices. For example, for a portable electronic device with a speaker port located on a bottom side of its housing, if the device is gripped by the user's hand, the speaker port may be blocked by one or more of the user's fingers. Additionally, users of portable electronic devices may prop up those devices with stands and other objects in such a way that the stands and other objects block the speaker ports. For example, if the portable electronic device is propped up with a stand having bottom prongs for securing the device, the speaker port may be blocked by one of those bottom prongs.

When a speaker port is fully occluded, the air that is pushed from the speaker diaphragm cannot escape through the speaker port. If some of the pushed air escapes through a partially occluded speaker port, the velocity of the moving air through the speaker port significantly increases compared to the velocity of the moving air through the speaker port if the port was not occluded. This increase in velocity results in turbulence in the speaker port which can result in audible distortion and/or physical discomfort for the user. Additionally, when a speaker port is partially or fully occluded, the air load on the speaker's driver changes which results in the speaker's resonance frequency shifting lower. Speaker systems are generally tuned for a particular resonance frequency. As a result, the speaker may not be driven in accordance with its specifications when there is a shift in the speaker's resonance frequency, which also results in audible distortion.

Features described herein overcome these problems by detecting a change in the speaker's resonance frequency and adjusting a gain of the speaker's amplifier based on the detected change. The speaker's resonance frequency can be detected by calculating impedances for the speaker when the speaker is driven with audio signals at certain frequencies. Based on a previously generated impedance curve model, the calculated impedances can be compared to the impedance curve model to detect the resonance change. The impedance curve model can be generated based on driving the speaker with test audio signals and calculating impedances and a change in operating temperature for the speaker in response to the test audio signals.

An impedance curve model can be generated for a particular speaker installed in the portable electronic device or the impedance curve model can be generated for a group of speakers during fabrication of the portable electronic device. In this way, a model can be customized for a particular speaker arrangement or can be generalized for a particular product line of the portable electronic device. The gain of the amplifier can be adjusted in real-time. Accordingly, if a speaker port is occluded during playback of certain content, the gain of the amplifier can be adjusted to correct any audible distortion that occurs until the occlusion is removed. To alert the user of the occlusion, a message can be generated that alerts the user of the potential occlusion. The gain may be adjusted for all frequencies used to drive the speaker or just a band of frequencies. The system can evaluate which frequencies distortion is most likely to occur in and adjust the gain in that frequency band.

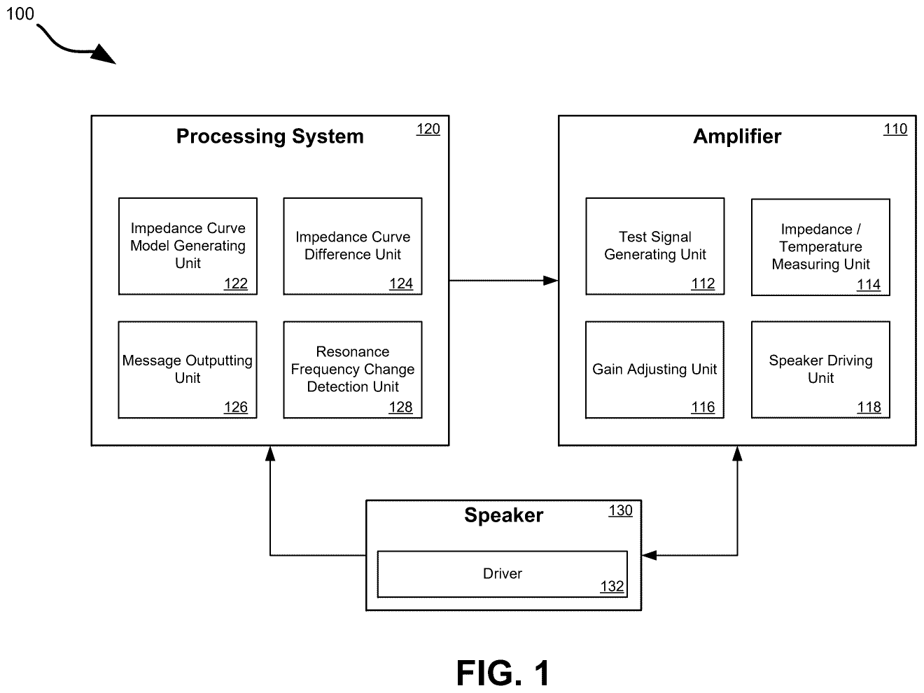

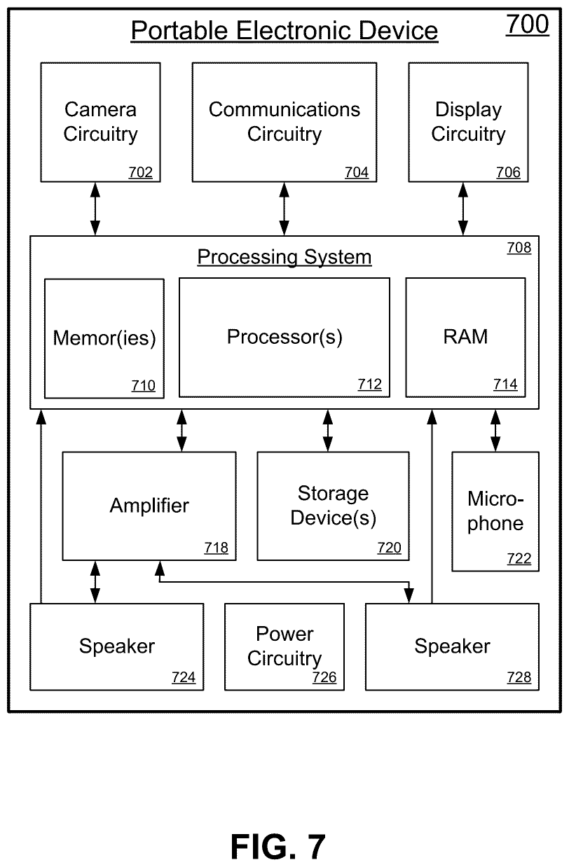

FIG. 1 shows an embodiment of a system 100 for detecting and correcting audible distortion. As shown in FIG. 1, the system 100 includes an amplifier 110, a processing system 120, and a speaker 130. In some embodiments, the amplifier 110, the processing system 120, and the speaker 130 form part of a portable electronic device, such as the portable electronic device described above and the portable electronic device 700 as shown in FIG. 7. In some embodiments, the portable electronic device may be implemented as a cellular, mobile, wireless, portable, smart, or radio telephone. In some embodiments, the portable electronic device may also be implemented as a mobile or electronic terminal device. In other embodiments, the portable electronic device may be implemented as a wearable device such as a smartwatch or head-mounted device. In further embodiments, the portable electronic device may be implemented as a home automation controller or smart home controlling device. Additionally, the portable electronic device may be implemented as a tablet computer, a phablet computer, a personal digital assistant, a notebook computer, a laptop computer, and the like. The foregoing implementations are not intended to be limiting and the amplifier 110, the processing system 120, and the speaker 130 form part of any kind of electronic device that is configured to detect and correct audible distortion of a speaker caused by occlusion of a speaker port for the speaker in accordance using the systems and methods disclosed herein.

The amplifier 110 includes a test signal generating unit 112, an impedance/temperature measuring unit 114, a gain adjusting unit 116, and a speaker driving unit 118. The amplifier 110 may include one or more special-purpose or general-purpose processors. Such special-purpose processors may include processors that are specifically designed to perform the functions of the test signal generating unit 112, the impedance/temperature measuring unit 114, the gain adjusting unit 116, the speaker driving unit 118, and other components detailed herein. Additionally, each of the test signal generating unit 112, the impedance/temperature measuring unit 114, the gain adjusting unit 116, and the speaker driving unit 118 may include one or more special-purpose or general-purpose processors that are specifically designed to perform the functions of those units. Such special-purpose processors may be application-specific integrated circuits (ASICs) or field-programmable gate arrays (FPGAs) which are general-purpose components that are physically and electrically configured to perform the functions detailed herein. Such general-purpose processors may execute special-purpose software that is stored using one or more non-transitory processor-readable mediums, such as random-access memory (RAM), flash memory, a hard disk drive (HDD), or a solid-state drive (SSD). Further, the functions of the components of the amplifier 110 can be implemented using a cloud-computing platform, which is operated by a separate cloud-service provider that executes code and provides storage for clients. In some embodiments, one or more functions of the test signal generating unit 112, the impedance/temperature measuring unit 114, the gain adjusting unit 116, and the speaker driving unit 118 may be performed by the processing system 120.

The gain adjusting unit 116 may amplify received audio signals based on a set gain. The audio signals are received from a source external to the amplifier 110. In some embodiments, the audio signals may be received from processing system 708 of portable electronic device 700 as shown in FIG. 7. In some embodiments, the amplifier 110 may be configured with one or more inputs (not shown) for receiving the audio signals. The gain may be set based on processing performed by the processing system 120. In some embodiments, the gain may be set by the resonance frequency change detection unit 128 of the processing system 120. For example, the gain may be set to correct for audible distortion and/or physical discomfort caused by occlusion of the speaker port for the speaker 130. In some embodiments, the gain may be set by a user. The gain adjusting unit 116 may amplify the received audio signals based on the set gain for each frequency of the audio signals. Additionally, the gain adjusting unit 116 may amplify the received audio signals based on the set gain for a band or bands of frequencies of the audio signals. In some embodiments, the gain adjusting unit 116 may include one for more filters, such as a notch filter, for amplifying the received audio signals. For examples, using a notch filter, the gain adjusting unit 116 may amplify certain frequencies of a received audio signal based on the set gain. The speaker driving unit 118 may drive the driver 132 of the speaker 130 with the amplified audio signals. The amplified audio signals have frequencies in a frequency range from 20 Hertz to 20,000 Hertz. In some embodiments, the amplified audio signals may have frequencies below 20 Hertz and/or above 20,000 Hertz. The audio signals may include music, video, streaming content, other sounds, operational sounds of a device incorporating the speaker, and the like.

The test signal generating unit 112 may generate a first test audio signal having a single frequency. The first test audio signal may have a frequency within a 20 Hertz −20,000 Hertz frequency range. The test signal generating unit 112 may also generate a second test audio signal having different frequencies. The second test audio may have a first frequency within a first frequency band (e.g., sub-bass frequency band), which corresponds to frequencies ranging between 20 Hertz and 60 Hertz. The second test audio signal may have a second frequency within a second frequency band (e.g., a bass frequency band), which corresponds to frequencies ranging between 60 Hertz and 250 Hertz. The second test audio signal may have a third frequency within a third frequency band (e.g., low midrange frequency band), which corresponds to frequencies ranging between 250 and 500 Hertz. The second test audio signal may have a fourth frequency within a fourth frequency band (e.g., a midrange frequency band), which corresponds to frequencies ranging between 500 Hertz and 2,000 Hertz. The second test audio signal may have a fifth frequency within a fifth frequency band (e.g., upper midrange frequency band), which corresponds to frequencies ranging between 2,000 Hertz and 4,000 Hertz. The second audio signal may have a sixth frequency within a sixth frequency band (e.g., a presence frequency band), which corresponds to frequencies ranging between 4,000 Hertz and 6,000 Hertz. The second test audio signal may have a seventh frequency within a seventh frequency band (e.g., a brilliance frequency band), which corresponds to frequencies ranging between 6,000 Hertz and 20,000 Hertz. The frequencies of the second test audio signal generated by the test signal generating unit 112 described above are not intended to be limiting. The second test audio signal generated by the test signal generating unit 112 may have any number of frequencies within a 20 Hertz −20,000 Hertz frequency range.

During an audio playback mode, the speaker driving unit 118 drives the driver 132 of the speaker 130 with an amplified audio signal for an audio playback period. The audio playback period may be configured to be a playback period lasting at least five (5) seconds. During an impedance curve model generating mode, the speaker driving unit 118 drives the driver 132 of the speaker 130 with the first test audio signal for a first test sampling period and drives the driver 132 of the speaker 130 with the second test audio signal for a second test sampling period. The first test sampling period may be configured to be a sampling period lasting between a half second (0.5) and one second (1). The second test sampling period may also be configured to be a sampling period lasting between a half second (0.5) and one second (1). The first test sampling period and the second test sampling period may be the same length of time or different lengths of time. The speaker driving unit 118 may be configured to drive the driver 132 with the first test audio signal before or after driving the driver 132 with the second test audio signal. The speaker driving unit 118 may be configured to drive the driver 132 with the first test audio signal and second test audio signal after driving the driver 132 with the amplified audio signal.

The impedance/temperature measuring unit 114 may measure the voltage, the current, and the operating temperature of the driver 132 of the speaker 130 when the speaker 130 is being driven. During the audio playback mode, the impedance/temperature measuring unit 114 may measure the voltage and the current of the driver 132 when the speaker 130 is being driven with an amplified audio signal. During the impedance curve model generating mode, the impedance/temperature measuring unit 114 may measure the operating temperature of the driver 132 when the speaker 130 is being driven with the first test audio signal for the first test sampling period and measure the voltage and current of the driver 132 when the speaker 130 is being driven with the second test audio signal for the second test sampling period.

The voltage and the current of the driver 132 may be measured by sampling the voltage and the current of the driver 132 a number of times during a sampling period. In some embodiments, the voltage and the current of the driver 132 may be sampled at a rate between 8,000 and 48,000 times per one (1) second. In some embodiments, the sampling period may correspond to the audio playback period, the first test sampling period, and/or the second test sampling period. Similarly, the operating temperature of the driver 132 may be measured by obtaining the operating temperature of the driver 132 at the beginning of the sampling period and the end of the sampling period. In some embodiments, the operating temperature may be obtained with a temperature sensor included in speaker 130. In some embodiments, the operating temperature of the driver 132 may be obtained between the beginning of the sampling period and the end of the sampling period. For example, if the first test sampling period is one (1) second in length, the operating temperature of the driver 132 may be measured once at the beginning of the first test sampling period and once at the end of the first test sampling period. Similarly, if the second test sampling period is one (1) second in length, the voltage and current of the driver 132 may be measured 44,100 times during the second test sampling period. Additionally, for the amplified audio signal, if the speaker 130 is driven with the amplified audio signal for five minutes, the voltage and current of the driver 132 may be measured up to 14.4 million times.

The processing system 120 includes an impedance curve model generating unit 122, an impedance curve comparison unit 124, a resonance frequency change detection unit 128, and a message outputting unit 126. The processing system 120 may include one or more special-purpose or general-purpose processors. Such special-purpose processors may include processors that are specifically designed to perform the functions of the impedance curve model generating unit 122, the impedance curve comparison unit 124, the resonance frequency change detection unit 128, the message outputting unit 126, and other components detailed herein. Additionally, each of the impedance curve model generating unit 122, the impedance curve comparison unit 124, the resonance frequency change detection unit 128, and the message outputting unit 126 may include one or more special-purpose or general-purpose processors that are specifically designed to perform the functions of those units. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as RAM, flash memory, an HDD, or an SSD. Further, the functions of the components of the processing system 120 can be implemented using a cloud-computing platform, which is operated by a separate cloud-service provider that executes code and provides storage for clients. In some embodiments, one or more functions of the impedance curve model generating unit 122, the impedance curve comparison unit 124, the resonance frequency change detection unit 128, and the message outputting unit 126 may be performed by the amplifier 110.

The impedance curve model generating unit 122 may generate an impedance curve model for the speaker 130 during the impedance curve model generating mode and an impedance curve for the speaker 130 during the audio playback mode. The impedance curve model for the speaker 130 may be calculated using the voltage and current measurements obtained while the speaker 130 is driven with the second test audio signal and a change in the operating temperature of the driver 132 while the speaker 130 is driven with the first test audio signal. For all frequencies of the second test audio signal, impedance for a given frequency may be calculated by dividing the voltage measured at the given frequency with the current measured at the given frequency. The calculated impedance at the given frequency may be adjusted based on a relative resistance calculated based on the change in the operating temperature of the driver 132 and a temperature coefficient of resistance of the material that forms the voice-coil conductor of the driver 132. For example, if the voice-coil conductor material of the driver 132 is copper, a relative resistance of the voice-coil conductor material will vary by a factor of approximately 1.73 over a 180° Celsius change in operating temperature of the driver 132. The relative resistance may be used to adjust the calculated impedance at the given frequency. For example, the calculated impedance for a given frequency may be scaled up or down based on the relative resistance. In this way, an impedance for each frequency of the second test audio signal may be calculated. The impedance calculated based on the first and second test audio signals is stored by the processing system 120 as the impedance curve model.

The impedance curve for the speaker 130 may be calculated using the voltage and current measurements obtained while the speaker 130 is driven with the amplified audio signal. As with the impedance curve model, impedance for a given frequency of the amplified audio signal may be calculated by dividing the voltage measured at the given frequency with the current measured for the given frequency. The impedance calculated based on the amplified audio signal for all frequencies of the amplified audio signal is stored by the processing system 120 as the impedance curve.

The impedance curve difference unit 124 may calculate an impedance difference curve based on differences in impedance between the impedance curve and impedance curve model. The impedance difference curve may be calculated by comparing an impedance for a given frequency in the impedance curve to an impedance in the impedance curve model for the given frequency to obtain a difference between the impedances. A comparison of impedances is made for each frequency that is common to both the impedance curve and the impedance curve model to obtain differences for each common frequency. For example, if the impedance curve model ranges from 100 Hertz to 15,000 Hertz, impedances for the frequency band 100 Hertz to 15,000 Hertz in the impedance curve may be compared to impedances in the impedance curve model. Based on the comparisons, impedance differences for all common frequencies may be stored in the impedance difference curve by the processing system 102.

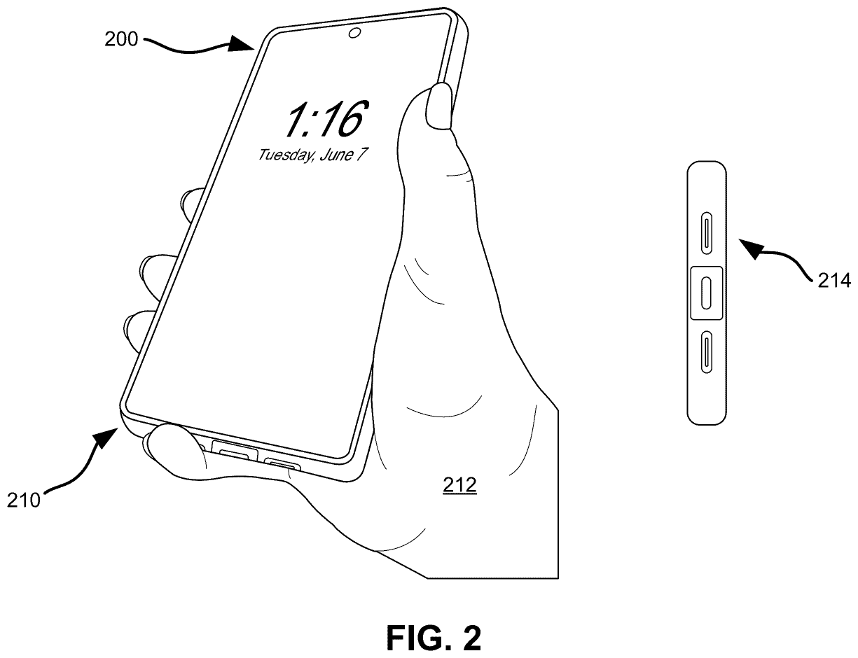

As discussed above, when the speaker 130 is driven during audio playback mode, air is pushed from the speaker diaphragm (not shown) of the speaker 130 through the speaker port 214 (FIG. 2). Users of portable electronic devices may hold and grip these devices with their hands in such a way that their hands and/or fingers block the speaker port 214. For example, as shown in FIG. 2, for a portable electronic device 200 with a speaker port 214 located on a bottom side of its housing, if the device is gripped by the user's hand 212, the speaker port 214 may be blocked by one or more of the user's fingers 210. When the speaker port 214 is occluded, audible distortion may occur and/or the user may experience physical discomfort. This audible distortion and physical discomfort may be corrected by detecting changes in the speaker's 130 resonance frequency.

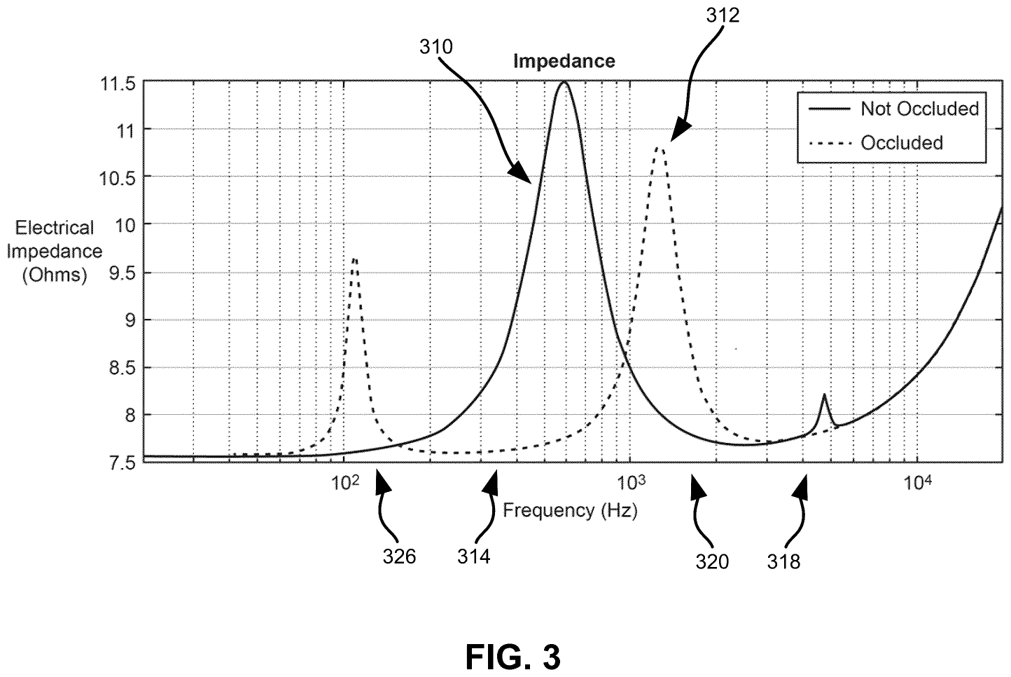

The resonance frequency change detection unit 128 may detect a change in the resonance frequency of the speaker 130 caused by occlusion of a speaker port for the speaker 130. FIG. 3 shows an example of an impedance curve model 310 and an impedance curve 312 for an exemplary speaker when a speaker port for the speaker is occluded. As shown in FIG. 3, the primary resonance frequency of the speaker when the speaker port is not occluded shifts from a higher frequency 314 to a lower frequency 326 when the speaker port is occluded. Similarly, a secondary resonance frequency of the speaker when the speaker port is not occluded shifts from a higher frequency 318 to a lower frequency 320 when the speaker port is occluded. The resonance frequency change detection unit 128 may detect the change by sampling the impedance difference curve to determine whether any impedance differences of the impedance difference curve exceed a predetermined threshold. In some embodiments, the resonance frequency change detection unit 128 may sample the impedance difference curve periodically. In some embodiments, the resonance frequency change detection unit 128 may sample the impedance difference curve at different frequencies, such as once every 25-50 Hertz along the entire impedance curve. For example, if the impedance difference curve ranges in frequency from 100 Hertz to 15,000 Hertz, the resonance frequency change detection unit 128 may sample the impedance difference curve once every 25 Hertz to obtain 596 samples. The foregoing sampling rates are not intended to be limiting. The impedance difference curve may be sampled at a rate in which the resonance frequency change detection unit 128 may detect a resonance frequency shift based on the samples.

The resonance frequency change detection unit 128 may further compare each sample obtained from the impedance difference curve to a predetermined threshold. The predetermined threshold may correspond to a percentage difference between the impedance curve model and the impedance curve. In some embodiments, the predetermined threshold may correspond to a 10% difference between the impedance curve model and the impedance curve. In some embodiments, any impedance differences between the impedance difference curve model and impedance curve that are 10% or greater are considered to be part of a resonance shift. Any frequencies of the impedance difference curve in which an impedance difference for a respective frequency corresponds to at least a 10% difference between the impedance curve model and the impedance curve are recorded and stored by the processing system 120. The foregoing threshold is not limiting. For example, the predetermined threshold may correspond to a 2%, 5%, 15% difference and the like. The predetermined threshold may correspond to any percentage in which the resonance frequency change detection unit 128 may detect a resonance frequency shift based on the predetermined threshold.

The resonance frequency change detection unit 128 may further analyze stored frequencies. In some embodiments, the resonance frequency change detection unit 128 may group the stored frequencies into one or more groups based on the analysis. In some embodiments, the analysis may be performed by a clustering algorithm or any suitable algorithm for grouping data. In some embodiments, the clustering algorithm may be configured to identify groups of similar frequencies among the stored frequencies. The resonance frequency change detection unit 128 may determine that a resonance shift has occurred if the analysis results in one or more groupings of similar frequencies.

Upon detecting that a resonance shift has occurred, the resonance frequency change detection unit 128 may set the gain of the amplified audio signal to correct for audible distortion caused by occlusion of the speaker port for the speaker 130. The resonance frequency change detection unit 128 may continuously compare the impedance curve during the audio playback to the impedance curve model to detect a resonance frequency shift and set the gain to correct the resonance frequency shift. The resonance frequency change detection unit 128 may set the gain in order to lower the amplitude of the amplified audio signal. In some embodiments, the resonance frequency change detection unit 128 may set the gain in order to decrease the volume of the audio output by the speaker 130. In some embodiments, the gain may be set to lower the amplitude of the amplified audio signal or the volume of the audio output by the speaker 130 whenever the resonance frequency change detection unit 116 detects a shift in the resonance frequency for the speaker 130.

In some embodiments, the gain may be set for each frequency of the amplified audio signal or a band of frequencies of the amplified audio signal that correspond to the one or more groups of similar frequencies. In some embodiments, the gain may be set to lower the amplitude of the amplified audio signal or the volume of the audio output by the speaker 130 by a predetermined amount. In some embodiments, the predetermined amount may be a first amount and the gain adjusting unit 116 may incrementally lower the amplitude of the amplified audio signal until the resonance frequency change detection unit 128 detects the resonance frequency shift is no longer occurring.

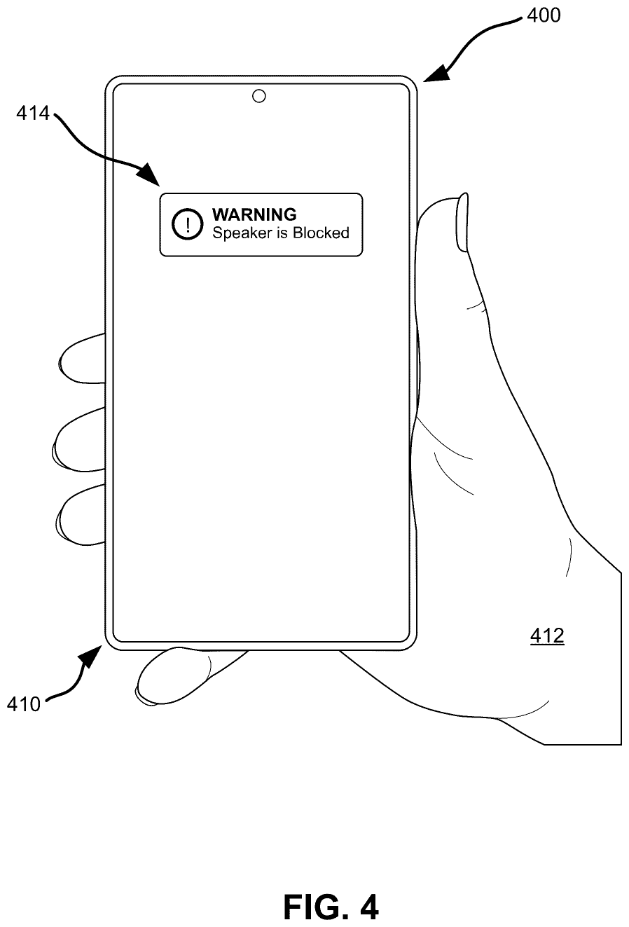

The messaging outputting unit 126 may generate a message that indicates to a user that a speaker port is occluded. FIG. 4 shows an example of a message 414 that indicates to a user that a speaker port for a speaker of a portable electronic device 400 is blocked. As shown in FIG. 4, a user may grip the portable electronic device 400 with their hand 412 such that the speaker port of the speaker may be blocked by one or more of the user's fingers 410 (e.g., the user's pinky finger) and a message 414 may be displayed on a display of the portable electronic device 400 that indicates that the speaker is blocked.

The message may include one or more phrases that inform the user that a speaker of the portable electronic device is occluded or partially occluded, that identify the speaker that is occluded (e.g., the speaker on the left side of the device), and/or instruct the user to remove the occlusion. Additionally, or alternatively, an audible message can be output by a speaker of the portable electronic device and/or a haptic message can be output by the portable electronic device. In some embodiments, the audible message may be a speech message of the message displayed on the display. In some embodiments, the haptic message may include one or more vibration patterns that vibrate the portable electronic device. The message may continue to be generated for as long as the speaker port is occluded. For example, when the speaker port ceases to be occluded, the message may cease being output. In some embodiments, the message may be generated for a predetermined period of time. In some embodiments, the message may be configured according to alert and notification settings of the portable electronic device.

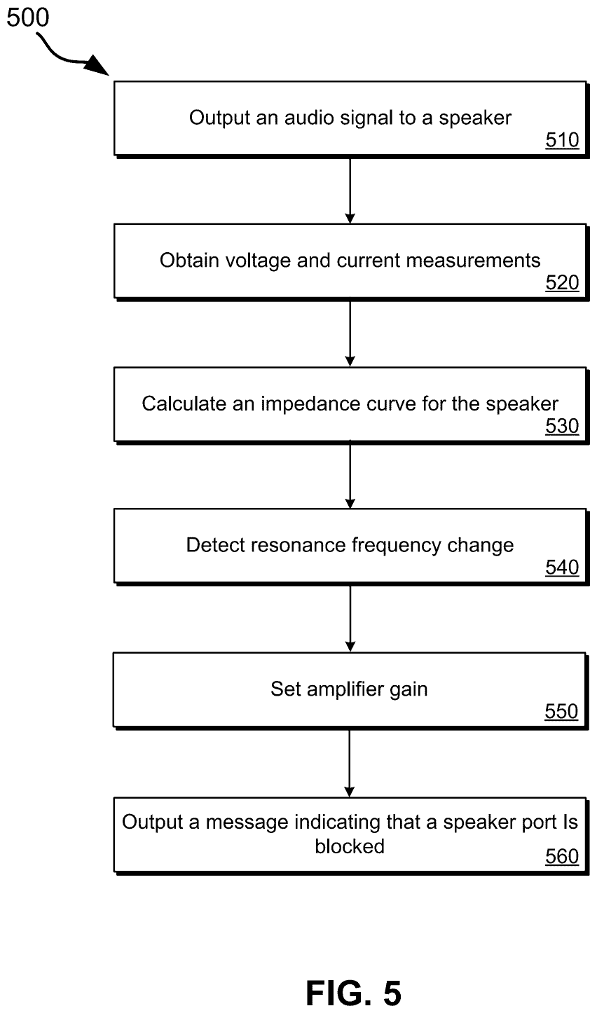

FIG. 5 shows a flowchart of an embodiment of a process 500 for detecting and correcting audible distortion. In some embodiments, the process 500 is implemented by the system 100 for detecting and correcting audible distortion. In some embodiments, the process 500 is implemented by a portable electronic device, such as the portable electronic device described above and the portable electronic device 700 as shown in FIG. 7. The process 500 can be implemented in software or hardware or any combination thereof.

At block 510, a first audio signal is output, from an amplifier to a speaker in an audio playback mode. The first audio signal may have frequencies in a frequency range from 20 Hertz to 20,000 Hertz. In some embodiments, the first audio signal may have frequencies below 20 Hertz and/or above 20,000 Hertz. The first audio signal is output for an audio playback period. The audio playback period may be configured to be a playback period lasting at least five (5) seconds. The first audio signal may be received from a source external to the amplifier. In some embodiments, the first audio signal may be received from processing system 708 of portable electronic device 700 as shown in FIG. 7. In some embodiments, the amplifier may be configured with one or more inputs (not shown) for receiving the first audio signal. The first audio signal may include music, video, streaming content, other sounds, operational sounds of a device incorporating the speaker, and the like.

At block 520, voltage and current measurements of a driver driving the speaker with the first audio signal are obtained. Voltage and current measurements of the driver 132 may be obtained by sampling the voltage and the current of the driver a number of times during a sampling period. In some embodiments, the voltage and the current of the driver may be sampled at a rate between 8,000 and 48,000 times per one (1) second. In some embodiments, the sampling period may correspond to the audio playback period.

At block 530, a first impedance curve for the speaker based on the first audio signal is calculated by a processing system coupled to the amplifier. The first impedance curve for the speaker may be calculated using the voltage and current measurements obtained while the speaker is driven with the first audio signal. Impedance for a given frequency of the first audio signal may be calculated by dividing the voltage measured at the given frequency with the current measured for the given frequency. The impedance calculated based on the first audio signal for all frequencies of the first audio signal is stored by the processing system as the first impedance curve.

At block 540, a change in a resonance frequency for the speaker is detected by the processing system. The change in the resonance frequency for the speaker is detected by calculating an impedance difference curve based on differences in impedance between the impedance curve and impedance curve model. The impedance difference curve may be calculated by comparing an impedance for a given frequency in the impedance curve to an impedance in the impedance curve model for the given frequency to obtain a difference between the impedances. A comparison of impedances is made for each frequency that is common to both the impedance curve and the impedance curve model to obtain differences for each common frequency. For example, if the impedance curve model ranges from 100 Hertz to 15,000 Hertz, impedances for the frequency band 100 Hertz to 15,000 Hertz in the impedance curve may be compared to impedances in the impedance curve model. Based on the comparisons, impedance differences for all common frequencies may be stored in the impedance difference curve by the processing system.

The change in the resonance frequency for the speaker is further detected by sampling the impedance difference curve to determine whether any impedance differences of the impedance difference curve exceed a predetermined threshold. In some embodiments, the impedance difference curve may be sampled periodically. In some embodiments, the impedance difference curve may be sampled at different frequencies, such as once every 25-50 Hertz along the entire impedance curve. For example, if the impedance difference curve ranges in frequency from 100 Hertz to 15,000 Hertz, the resonance frequency change detection unit 128 may sample the impedance difference curve once every 25 Hertz to obtain 596 samples. The foregoing sampling rates are not intended to be limiting. The impedance difference curve may be sampled at a rate in which a resonance frequency shift may be detected based on the samples.

The change in the resonance frequency for the speaker is further detected by comparing each sample obtained from the impedance difference curve to a predetermined threshold. The predetermined threshold may correspond to a percentage difference between the impedance curve model and the impedance curve. In some embodiments, the predetermined threshold may correspond to a 10% difference between the impedance curve model and the impedance curve. In some embodiments, any impedance differences between the impedance difference curve model and impedance curve that are 10% or greater are considered to be part of a resonance shift. Any frequencies of the impedance difference curve in which an impedance difference for a respective frequency corresponds to at least a 10% difference between the impedance curve model and the impedance curve are recorded and stored by the processing system 120. The foregoing threshold is not limiting. For example, the predetermined threshold may correspond to a 2%, 5%, 15% difference and the like. The predetermined threshold may correspond to any percentage in which the resonance frequency shift may be detected based on the predetermined threshold.

The change in the resonance frequency for the speaker is further detected by analyzing the stored frequencies. In some embodiments, the stored frequencies may be grouped into one or more groups based on the analysis. In some embodiments, the analysis may be performed by a clustering algorithm or any suitable algorithm for grouping data. In some embodiments, the clustering algorithm may be configured to identify groups of similar frequencies among the stored frequencies. In some embodiments, a resonance shift is determined to have occurred if the analysis results in one or more groupings of similar frequencies.

At block 550, a gain of the amplifier is set based on the detected change in the resonance frequency for the speaker. The gain may be set in order to lower the amplitude of the amplified audio signal. In some embodiments, the gain may be set in order to decrease the volume of the audio output by the speaker. In some embodiments, the gain may be set to lower the amplitude of the amplified audio signal or the volume of the audio output by the speaker whenever a shift in the resonance frequency for the speaker is detected. In some embodiments, the gain may be set for each frequency of the amplified audio signal or a band of frequencies of the amplified audio signal that correspond to the one or more groups of similar frequencies. In some embodiments, the gain may be set to lower the amplitude of the amplified audio signal or the volume of the audio output by the speaker by a predetermined amount. In some embodiments, the predetermined amount may be a first amount and the gain may incrementally lower the amplitude of the amplified audio signal until the resonance frequency is not long shifted.

At block 560, in some embodiments, a message to a user of the portable electronic device may be output. The message may include one or more phrases that inform the user that a speaker of the portable electronic device is occluded or partially occluded, that identify the speaker that is occluded (e.g., the speaker on the left side of the device), and/or instruct the user to remove the occlusion. Additionally, or alternatively, an audible message can be output by a speaker of the portable electronic device and/or a haptic message can be output by the portable electronic device. In some embodiments, the audible message may be a speech message of the message displayed on the display. In some embodiments, the haptic message may include one or more vibration patterns that vibrate the portable electronic device. The message may continue to be generated for as long as the speaker port is occluded. For example, when the speaker port ceases to be occluded, the message may cease being output. In some embodiments, the message may be generated for a predetermined period of time. In some embodiments, the message may be configured according to alert and notification settings of the portable electronic device.

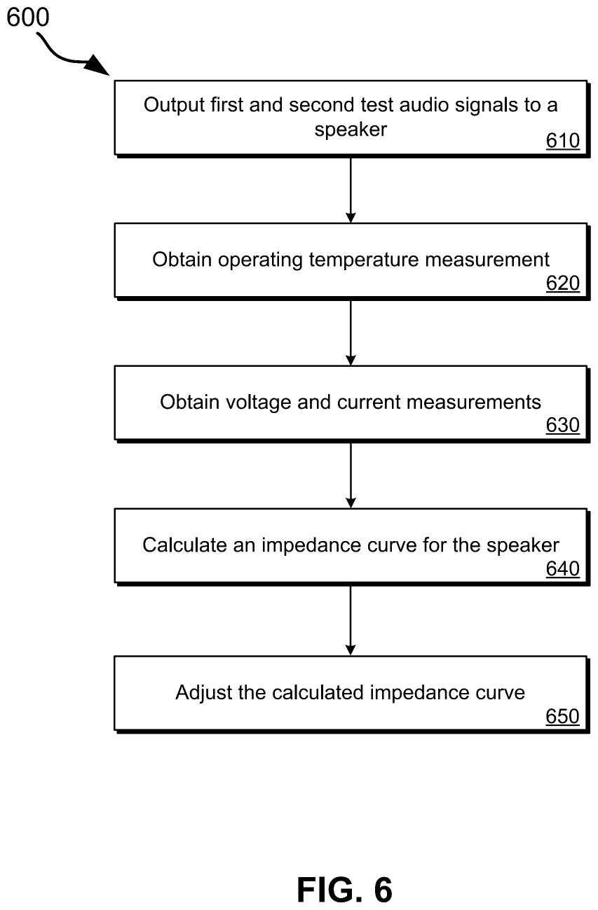

FIG. 6 shows a flowchart of an embodiment of a process 600 for generating an impedance curve model. In some embodiments, the process 600 is implemented by the system 100 for detecting and correcting audible distortion. In some embodiments, the process 600 is implemented by a portable electronic device, such as the portable electronic device described above and the portable electronic device 700 as shown in FIG. 7. The process 600 can be implemented in software or hardware or any combination thereof.

At block 610, a first test audio signal having a frequency and second test audio signal having a plurality of test frequencies is output, from the amplifier to the speaker. The first test audio signal may have a frequency within a 20 Hertz −20,000 Hertz frequency range. The second test audio may have a first frequency within a first frequency band (e.g., sub-bass frequency band), which corresponds to frequencies ranging between 20 Hertz and 60 Hertz. The second test audio signal may have a second frequency within a second frequency band (e.g., a bass frequency band), which corresponds to frequencies ranging between 60 Hertz and 250 Hertz. The second test audio signal may have a third frequency within a third frequency band (e.g., low midrange frequency band), which corresponds to frequencies ranging between 250 and 500 Hertz. The second test audio signal may have a fourth frequency within a fourth frequency band (e.g., a midrange frequency band), which corresponds to frequencies ranging between 500 Hertz and 2,000 Hertz. The second test audio signal may have a fifth frequency within a fifth frequency band (e.g., upper midrange frequency band), which corresponds to frequencies ranging between 2,000 Hertz and 4,000 Hertz. The second audio signal may have a sixth frequency within a sixth frequency band (e.g., a presence frequency band), which corresponds to frequencies ranging between 4,000 Hertz and 6,000 Hertz. The second test audio signal may have a seventh frequency within a seventh frequency band (e.g., a brilliance frequency band), which corresponds to frequencies ranging between 6,000 Hertz and 20,000 Hertz. In further embodiments, the second test audio signal may have any number of frequencies within a 20 Hertz −20,000 Hertz frequency range.

In some embodiments, the first test audio signal is output for a first test sampling period and the second test audio signal is output for a second test sampling period. The first test sampling period may be configured to be a sampling period lasting between a half second (0.5) and one second (1). The second test sampling period may also be configured to be a sampling period lasting between a half second (0.5) and one second (1). The first test sampling period and the second test sampling period may be the same length of time or different lengths of time. The first test audio signal may be output before or after the second test audio signal. In some embodiments, the first test audio signal and second test audio signal may be output after outputting the first audio signal.

At block 620, an operating temperature measurement of the driver driving the speaker with the first test audio signal is obtained. The operating temperature of the driver may be measured by obtaining the operating temperature of the driver at the beginning of the sampling first test sampling period and the end of the first test sampling period. In some embodiments, the operating temperature may be obtained with a temperature sensor included in the speaker. In some embodiments, the operating temperature of the driver may be obtained between the beginning of the first test sampling period and the end of the first test sampling period. For example, if the first test sampling period is one (1) second in length, the operating temperature of the driver 132 may be measured once at the beginning of the first test sampling period and once at the end of the first test sampling period.

At block 630, voltage and current measurements of the driver driving the speaker with the second test audio signal are obtained. Voltage and current measurements of the driver may be obtained by sampling the voltage and the current of the driver a number of times during a sampling period. In some embodiments, the voltage and the current of the driver may be sampled at a rate between 8,000 and 48,000 times per one (1) second. In some embodiments, the sampling period may correspond to the second test sampling period.

At block 640, an impedance curve for the speaker based on the second test audio signal is calculated by the processing system coupled to the amplifier. The impedance curve for the speaker may be calculated using the voltage and current measurements obtained while the speaker is driven with the second test audio signal. For all frequencies of the second test audio signal, impedance for a given frequency of the second test audio signal may be calculated by dividing the voltage measured at the given frequency with the current measured for the given frequency. The impedance calculated based on the second test audio signal is stored by the processing system.

At block 650, the impedance curve for the speaker may be adjusted. The impedance curve may be adjusted based on a relative resistance calculated based on a change in the operating temperature of the driver and a temperature coefficient of resistance of the material that forms the voice-coil conductor of the driver. For example, if the voice-coil conductor material of the driver is copper, a relative resistance of the voice-coil conductor material will vary by a factor of approximately 1.73 over a 180° Celsius change in operating temperature of the driver. The relative resistance may be used to adjust the calculated impedance. For example, the calculated impedance for a given frequency may be scaled up or down based on the relative resistance. In this way, the impedance curve for each frequency of the second test audio signal may be adjusted. The impedance calculated based on the first and second test audio signals is stored by the processing system as the impedance curve model.

FIG. 7 shows an exemplary configuration of a portable electronic device 700. As shown in FIG. 7, the portable electronic device 700 includes camera circuitry 702, communications circuitry 704, display circuitry 706, a processing system 708, an amplifier 718, one or more storage devices 720, a microphone 722, speakers 724, 728, and power circuitry 726.

Processing system 708 includes one or more memories 710, one or more processors 712, and RAM 714. The one or more processors 712 can read one or more programs from the one or more memories 710 and execute them using RAM 714. The one or more processors 712 may be of any type including but not limited to a microprocessor, a microcontroller, a graphical processing unit, a digital signal processor, an ASIC, an FPGA, or any combination thereof. The one or more processors 712 can execute the one or more programs stored in the one or more memories 710 to perform operations as described herein including those described with respect to FIG. 1-6. Together with the amplifier 718, one or more of speakers 724, 728, and the display circuitry 706, the one or more processors 712 can detect and correct audible distortion caused by occlusion of a speaker port as described herein with respect to FIG. 1-6.

The one or more memories 710 can be non-volatile and may include any type of memory device that retains stored information when powered off. Non-limiting examples of memory include electrically erasable and programmable read-only memory (EEPROM), flash memory, or any other type of non-volatile memory. At least one memory of the one or more memories 710 can include a non-transitory computer-readable storage medium from which the one or more processors 712 can read instructions. A computer-readable storage medium can include electronic, optical, magnetic, or other storage devices capable of providing the one or more processors 712 with computer-readable instructions or other program code. Non-limiting examples of a computer-readable storage medium include magnetic disks, memory chips, ROM, RAM, an ASIC, a configured processor, optical storage, or any other medium from which a computer processor can read the instructions.

One or more storage devices 720 may be configured to store data received by and/or generated by the portable electronic device 700. The one or more storage devices 720 may be removable storage devices, non-removable storage devices, or a combination thereof. Examples of removable storage and non-removable storage devices include magnetic disk devices such as flexible disk drives and HDDs, optical disk drives such as compact disk (CD) drives or digital versatile disk (DVD) drives, SSDs, and tape drives.

The portable electronic device 700 may also include other components providing additional functionality. For example, camera circuitry 702 may be configured to capture images and video of a surrounding environment of the portable electronic device 700. Similarly, microphone 722 may be configured to record sounds from a surrounding environment of the portable electronic device 700. Additionally, communications circuitry 704 may be configured to enable the portable electronic device 700 to communicate with various wired or wireless networks and other various systems and devices. Power circuitry 726 may provide power to the portable electronic device 700 via a power supply incorporated therein and a charging circuity to charge the power supply.

The portable electronic device 700 may also include other input and output (I/O) components. Examples of such input components can include a mouse, a keyboard, a trackball, a touch pad, a touchscreen display, and the like. Examples of such output components can include a display of display circuitry 706 and a haptic feedback device. Examples of the display can include a liquid crystal display (LCD), a light-emitting diode (LED) display, and a touchscreen display. Examples of a haptic feedback device may include a piezoelectric vibration device or an eccentric rotating mass (ERM) device.

In some embodiments, the portable electronic device 700 may be implemented as a cellular, mobile, wireless, portable, smart, or radio telephone. In some embodiments, the portable electronic device 700 may also be implemented as a mobile or electronic terminal device. In other embodiments, the portable electronic device 700 may be implemented as a wearable device such as a smartwatch or head-mounted device. In further embodiments, the portable electronic device 700 may be implemented as a home automation controller or smart home controlling device. Additionally, the portable electronic device may be implemented as a tablet computer, a phablet computer, a personal digital assistant, a notebook computer, a laptop computer, and the like.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present disclosure as claimed has been specifically disclosed by embodiments and optional features, modification, and variation of the concepts herein disclosed may be resorted to by those skilled in the art, and that such modifications and variations are considered to be within the scope of this invention as defined by the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The above description of certain embodiments, including illustrated embodiments, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any embodiments described herein can be combined with any other embodiments.

1. A method for correcting audible distortion in a portable electronic device, comprising:
outputting, from an amplifier to a speaker, a first audio signal, the first audio signal having a plurality of first frequencies;
calculating, by a processing system coupled to the amplifier, a first impedance curve for the speaker based on the first audio signal;
detecting, by the processing system, a change in a resonance frequency for the speaker based on an impedance curve model for the speaker and the first impedance curve for the speaker; and
setting, by the processing system, a gain of the amplifier based on the detected change in the resonance frequency for the speaker.

2. The method for correcting audible distortion in the portable electronic device of claim 1, further comprising:
outputting, from the amplifier to the speaker, a first test audio signal having a frequency and second test audio signal having a plurality of test frequencies.

3. The method for correcting audible distortion in the portable electronic device of claim 2, further comprising:
calculating, by the processing system, an impedance curve model for the speaker based on the first test audio signal and the second test audio signal.

4. The method for correcting audible distortion in the portable electronic device of claim 3, wherein calculating the impedance curve model comprises:
obtaining an operating temperature measurement for a driver of the speaker while the speaker is driven with the first test audio signal; and
obtaining voltage and current measurements for the driver of the speaker while the speaker is driven with the second test audio signal.

5. The method for correcting audible distortion in the portable electronic device of claim 4, wherein calculating the impedance curve model further comprises:
calculating an impedance curve for the speaker based on the voltage and current measurements for the driver of the speaker; and
adjusting the calculated impedance curve for the speaker based on a relative resistance determined based on a change in the operating temperature measurement for the driver of the speaker.

6. The method for correcting audible distortion in the portable electronic device of claim 1, wherein the first audio signal is output, from the amplifier to the speaker, for a first period of time, and wherein adjusting the gain of the amplifier comprises adjusting an amplitude of the first audio signal for a period of time equal to or less than the first period of time.

7. The method for correcting audible distortion in the portable electronic device of claim 1, wherein adjusting the gain of the amplifier comprises adjusting a gain for each frequency of the plurality of first frequencies or a subset of frequencies of the plurality of first frequencies.

8. The method for correcting audible distortion in the portable electronic device of claim 1, wherein the change in the resonance frequency for the speaker corresponds to a change in a port velocity for a speaker port included in a housing of the portable electronic device, the speaker port being comprised of a plurality of openings in the housing, wherein the change in the port velocity is caused by an obstruction of at least one opening of the plurality of openings.

9. The method for correcting audible distortion in the portable electronic device of claim 1, further comprising:
outputting a message, by the processing system, the message indicating that a speaker port for the speaker is blocked.

10. The method for correcting audible distortion in the portable electronic device of claim 9, wherein the message is at least one of a visual message that is displayed on a display of the portable electronic device, an audible message that is output through a speaker of the portable electronic device, and a haptic message that is output by a vibrating device installed in a housing of the portable electronic device.

11. A portable electronic device comprising:
a housing comprising a speaker port;
an amplifier;
one or more speakers;
one or more processing systems coupled to the amplifier; and
one or more computer-readable storage media containing instructions which, when executed on the one or more processing systems, cause the one or more processing systems to perform operations including:
outputting, from the amplifier to a speaker of the one or more speakers, a first audio signal, the first audio signal having a plurality of first frequencies;
calculating a first impedance curve for the speaker based on the first audio signal;
detecting a change in a resonance frequency for the speaker based on an impedance curve model for the speaker and the first impedance curve for the speaker; and
setting a gain of the amplifier based on the detected change in the resonance frequency for the speaker.

12. The portable electronic device of claim 11, wherein the operations further include:
outputting, from the amplifier to the speaker, a first test audio signal having a frequency and second test audio signal having a plurality of test frequencies.

13. The portable electronic device of claim 12, wherein the operations further include:
calculating an impedance curve model for the speaker based on the first test audio signal and the second test audio signal.

14. The portable electronic device of claim 13, wherein calculating the impedance curve model comprises:
obtaining an operating temperature measurement for a driver of the speaker while the speaker is driven with the first test audio signal; and
obtaining voltage and current measurements for the driver of the speaker while the speaker is driven with the second test audio signal.

15. The portable electronic device of claim 14, wherein calculating the impedance curve model further comprises:
calculating an impedance curve for the speaker based on the voltage and current measurements for the driver of the speaker; and
adjusting the calculated impedance curve for the speaker based on a relative resistance determined based on a change in the operating temperature measurement for the driver of the speaker.

16. The portable electronic device of claim 11, wherein the first audio signal is output, from the amplifier to the speaker, for a first period of time, and wherein adjusting the gain of the amplifier comprises adjusting an amplitude of the first audio signal for a period of time equal to or less than the first period of time. 17 The portable electronic device of claim 11, wherein adjusting the gain of the amplifier comprises adjusting a gain for each frequency of the plurality of first frequencies or a subset of frequencies of the plurality of first frequencies.

18. The portable electronic device of claim 11, wherein the speaker port is comprised of a plurality of openings in the housing, and wherein the change in the resonance frequency for the speaker corresponds to a change in a port velocity for the speaker port caused by an obstruction of at least one opening of the plurality of openings.

19. The portable electronic device of claim 11, the operations further including:
outputting a message, the message indicating that a speaker port for the speaker is blocked, wherein the message is at least one of a visual message that is displayed on a display of the portable electronic device, an audible message that is output through a speaker of the portable electronic device, and a haptic message that is output by a vibrating device installed in a housing of the portable electronic device.

20. One or more non-transitory computer-readable media storing computer-readable instructions that, when executed by one or more processing systems, cause the one or more processing systems to perform operations including:
outputting, from an amplifier to a speaker, a first audio signal, the first audio signal having a plurality of first frequencies;
calculating a first impedance curve for the speaker based on the first audio signal;
detecting a change in a resonance frequency for the speaker based on an impedance curve model for the speaker and the first impedance curve for the speaker; and
setting a gain of the amplifier based on the detected change in the resonance frequency for the speaker.
